(19) United States
(12) Patent Application Publication
(10) Pub. No.: US 2016/0320013 A1
(43) Pub. Date: Nov. 3, 2016

(54) LAMP SHADE KIT AND METHOD OF ASSEMBLY

(71) Applicant: Design Solutions International, Ft. Lauderdale, FL (US)

(72) Inventor: Michael PERILLO, Coral Springs, FL (US)

(21) Appl. No.: 14/701,980

(22) Filed: May 1, 2015

(51) Int. Cl. F21V 1/14; F21V 17/08; F21V 17/04; F21V 1/02; F21V 1/26

(52) U.S. Cl. CPC F21V 1/14; F21V 1/02; F21V 1/26; F21V 17/04; F21V 17/08

(57) ABSTRACT

A lamp shade kit may be assembled by forming a lamp shade into a drum shape by attaching two vertically oriented Velcro® strips to each other, said strips being arranged on opposite edges of the lamp shade; inserting a plain ring into a lower bead formed along a lower periphery of the lamp shade; and inserting a spider ring into an upper bead formed along an upper periphery of the lamp shade; whereby the lamp shade kit is assembled and ready to be secured in place. Preliminarily, the lamp shade may be opened up into the drum shape from an initially rolled-up condition. Also, the spider ring may have either a swag ring or a finial ring in its center.

### BACKGROUND

Lamps and their shades are old and come in various sizes and shapes. Most lamps and their shades are pre-assembled by the manufacturer who ships them to a retailer for ultimate sale to consumers. Such lamps and their shades are often expensive and require great care in unpacking them for display by the retailer and also in taking them home for use by the consumer. All other known so-called knock-down shades on the market utilize bars or arms that require the consumer to snap them together into place. In other words, the consumer basically must build the shade. Thus, it is a problem in the industry to provide consumers with lamps and shades which are safe to deliver, relatively inexpensive, and easily assembled by the consumer.

### SUMMARY

This summary is provided to introduce a selection of concepts. These concepts are further described below in the detailed description in conjunction with the accompanying drawings. This summary is not intended to identify key or essential features of the claimed subject matter, nor is this summary intended as an aid in determining the scope of the claimed subject matter.

According to one implementation, there is a lamp shade kit which, when assembled, provides a lamp shade which hangs from an electrical socket.

According to another implementation, there is a lamp shade kit which, when assembled, provides a lamp shade which sits on top of a vertical pole of either a table lamp or a floor lamp.

According to another implementation, there is a method for assembling the lamp shade from the kit.

One unique feature of the collapsible, knock-down, drum-shaped shade of the present invention is tis convertibility and dual use which allows the consumer to choose whether to use the shade on a table lamp, on a pole lamp or as a hanging swag-style drum pendant.

Another unique feature is its packaging which is designed to have the shade rolled up in a shipping box so that, upon removal from the box, the shade is unrolled and attached at its opposite ends by Velcro® strips to form a drum shape. The rolled-up condition in the box keeps the collapsible shade from ever becoming wrinkled or creased while shipping.

Yet another unique feature is the assembly with rings. No other known collapsible drum-shaped shade on the market utilizes these spider rings to support the shade on either a lamp base with a harp and a finial or, using a cord and socket, hangs the drum-shaped shade from a hook in the ceiling overhead.

A further unique feature is the assembly of the shade. This unique assembly requires the consumer only to place the spider rings into place inside beads along the periphery of the shade. The rings provide structure to hold the shade in place, as well as to keep the shade in its round, sturdy, drum shape.

The above summary is not intended to describe each embodiment or every implementation. Further features, their nature and various advantages are described in the accompanying drawings and the following detailed description of the examples and embodiments.

### BRIEF DESCRIPTION OF THE DRAWINGS

The accompanying drawings, which are incorporated in and constitute a part of this specification, illustrate one or more embodiments described herein and, together with the description, explain these embodiments. In addition, it should be understood that the drawings are presented for example purposes only. In the drawings:

FIG. 1 shows an exploded view illustrating an exemplary lamp shade kit, according to a first embodiment;

FIG. 2A shows a perspective view illustrating a rolled-up lamp shade, according to a second embodiment;

FIG. 2B shows a perspective view illustrating a swag-type spider ring, according to the second embodiment;

FIG. 2C shows a perspective view illustrating a finial-type spider ring, according to the second embodiment;

FIG. 2D shows a perspective view illustrating a plain ring, according to the second embodiment;

FIG. 3 shows a perspective view illustrating the rolled-up lamp shade in an unrolled condition, according to the second embodiment;

FIG. 4 shows a perspective view illustrating the unrolled lamp shade being formed into a drum shape by attaching Velcro® strips to each other, according to the first and second embodiments;

FIG. 5 shows a perspective view illustrating insertion of the plain ring into a lower bead of the lamp shade, according to the first and second embodiments;

FIG. 6 shows a perspective view illustrating the lamp shade after insertion of the plain ring into the lower bead, according to the first and second embodiments;

FIG. 7A shows a perspective view illustrating insertion of the swag-type spider ring into an upper bead of the lamp shade, according to the first and second embodiments;

FIG. 7B shows a perspective view illustrating the lamp shade after insertion of the swag-type spider ring into the upper bead, according to the first and second embodiments;

FIG. 8A shows a perspective view illustrating insertion of the finial-type spider ring into the upper bead of the lamp shade, according to the first and second embodiments;

FIG. 8B shows a perspective view illustrating the lamp shade after insertion of the finial-type spider ring into the upper bead, according to the first and second embodiments;

FIG. 9 shows a perspective view illustrating the lamp shade with its swag-type spider ring attached to a vertically hanging flexible cord, according to the first and second embodiments;

FIG. 10 shows a perspective view illustrating the lamp shade with its swag-type spider ring attached to an arching rigid rod, according to the first and second embodiments; and

FIG. 11 shows a perspective view illustrating the lamp shade with its finial-type spider ring attached to a harp of a portable standing pole, according to the first and second embodiments.

The following detailed description refers to the accompanying drawings. The same reference numbers in different drawings identify the same or similar elements.

### DETAILED DESCRIPTION

The present invention is directed to lamp shades and related methods for assembling them. The present invention is particularly advantageous for reducing breakage by having the consumer assemble the lamp shade at home, rather than being assembled at the factory or in a retail store where breakage is more likely to occur. In the present invention, the apparatus is adaptable to be converted from a hanging lamp shade to a portable lamp shade and vice versa because the lamp shade kit is provided with two different kinds of spider rings. According to one embodiment, the lamp shade may be rolled up and placed next to a small box within a larger box provided for the kit. According to another embodiment, the lamp shade may be rolled up in a single box provided for the kit. These kinds of unassembled lamp shades are often called “knock downs” and usually have a drum shape when assembled.

Although described specifically throughout the entirety of the disclosure, the representative examples have utility over a wide range of applications, and the above discussion is not intended and should not be construed to be limiting. The terms, descriptions, and figures used herein are set forth by way of illustration only and are not meant as limitations. Those persons skilled in the art recognize that many variations are possible within the spirit and scope of the principles of the invention. While the examples below are described with reference to the figures, those persons skilled in the art are able to make various modifications to the described examples without departing from the scope of the following claims, and their equivalents.

The operation and effects of certain embodiments can be more fully appreciated from the examples, as described below. The embodiments on which these examples are based are representative only. The selection of these embodiments to illustrate the principles of the invention does not indicate that materials, components, conditions, techniques, configurations and designs, etc., which are not described in the examples are not suitable for use, or that subject matter not described in the examples is excluded from the scope of the appended claims or their equivalents.

As used herein, the terms “based on”, “comprises”, “comprising”, “includes”, “including”, “has”, “having” or any other variation thereof, are intended to cover a nonexclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition A or B is satisfied by any one of the following: A is true (or present) and B is false (or not present), A is false (or not present) and B is true (or present), and both A and B are true (or present). Also, use of the “a” or “an” is employed to describe elements and components. This usage is done merely for convenience and to give a general sense of the description. This description should be read to include one or at least one and the singular also includes the plural, unless it is clear that it is meant otherwise.

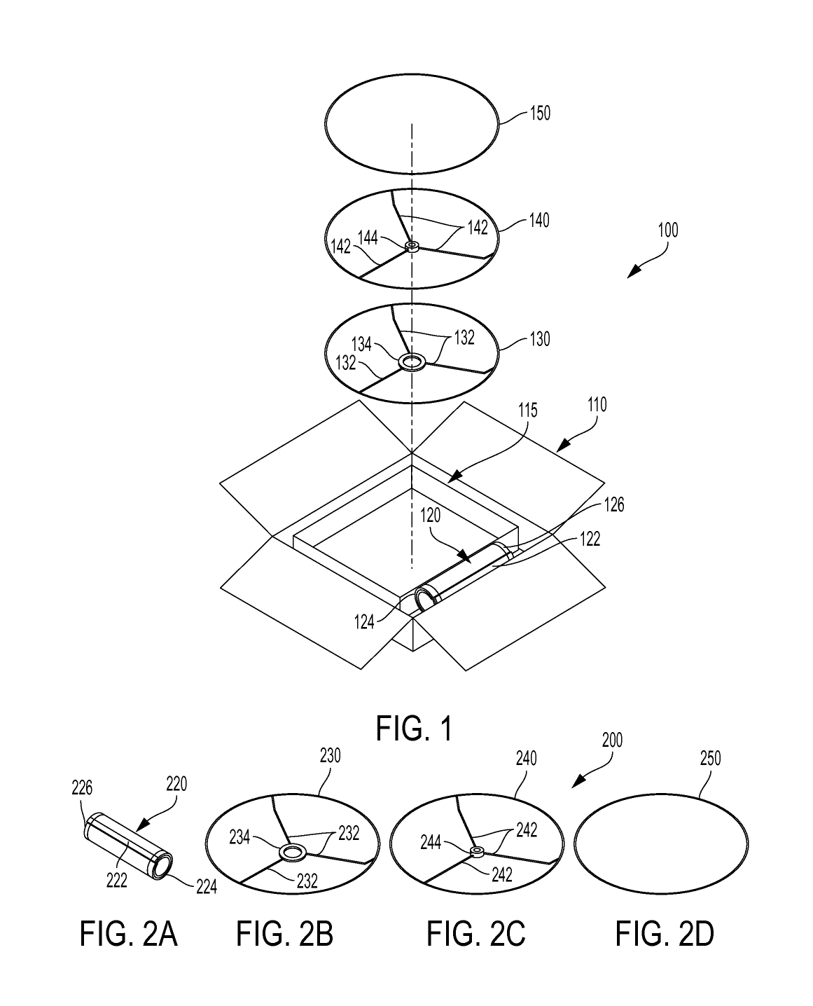

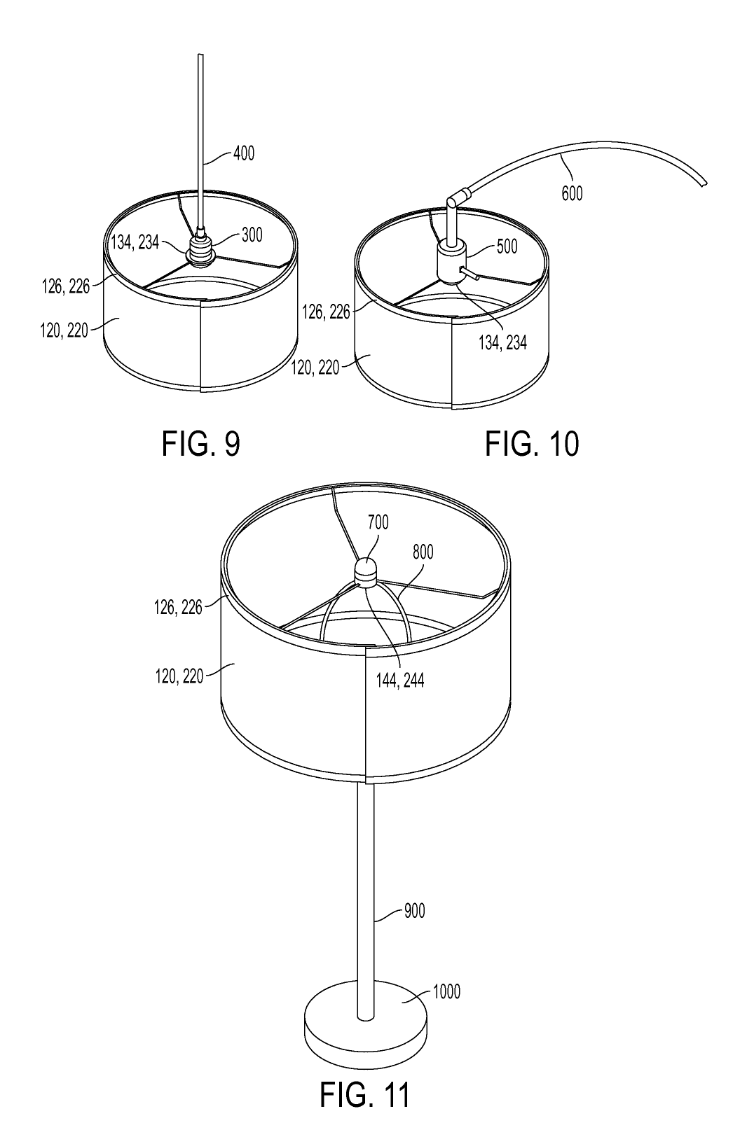

FIG. 1 demonstrates an exemplary lamp shade kit 100 according to an implementation described herein. The kit 100 includes a first large box 110 with flaps, a second small box 115 without flaps, a rolled-up lamp shade 120, a swag-type spider ring 130, a finial-type spider ring 140, and a plain ring 150. The rolled-up lamp shade 120 has a Velcro® strip 122, a lower bead 124 formed on its lower periphery, and an upper bead 126 formed on its upper periphery. The three rings 130, 140 and 150 may be made of either metal or hard plastic. The spider rings 130 and 140 have three spider legs 132 and 142, respectively. Although three spider legs 132 and 142 are shown, four legs may also be used. The swag-type spider ring 130 has a large inner swag ring 134 at its center for the purpose of engaging around an electrical socket (see FIGS. 9 & 10). The finial-type spider ring 140 has a small inner finial ring 144 for encircling a top of a harp of a portable lamp (see FIG. 11).

According to the second example demonstrated in FIGS. 2A-2D, a single box for holding a similar kit 200 is not shown. FIG. 2A shows a rolled-up lamp shade 220 with a Velcro® strip 222, a lower bead 224 formed along it lower peripheral edge, and an upper bead 226 formed along its upper peripheral edge. FIG. 2B shows a swag-type spider ring 230 with three spider legs 232, which may be either bent or straight. The three spider legs 232 are attached at their inner ends to a large inner swag ring 234 which is configured to fit around an electrical socket (not shown in FIG. 2B, but see FIGS. 9 and 10). FIG. 2C shows a finial-type spider ring 240 with three spider legs 242, which may be either bent or straight. The three spider legs 242 are attached at their inner ends to a small inner finial ring 234 which is configured to fit around a harp (not shown in FIG. 2C, but see FIG. 11) of a portable lamp. FIG. 2D shows a plain ring 250 which is dimensioned to fit into either the lower bead 124 of the rolled-up shade 120 seen in FIG. 1 or the lower bead 224 of the rolled-up shade 220 seen in FIG. 2A, when the shades 120 and 220 are opened up into a drum shape.

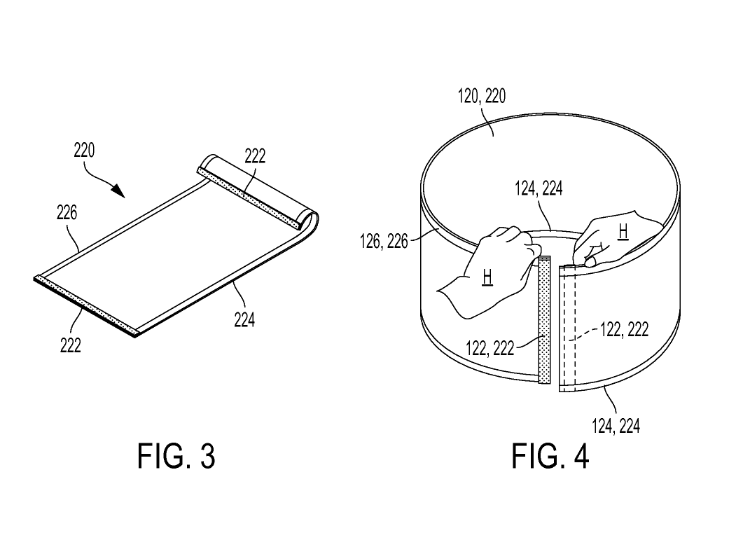

In FIG. 3, the shade 220 is unrolled from its initially rolled-up condition to show the two vertically oriented Velcro® strips 222 on opposite edges thereof, the lower bead 224, and the upper bead 226. In FIG. 4, hands H of the consumer are shown attaching the two Velcro^{R} strips 122, 222 together to form the shade 120, 220 into a drum shape with the lower bead 124, 224 and the upper bead 126, 226 ready to receive rings.

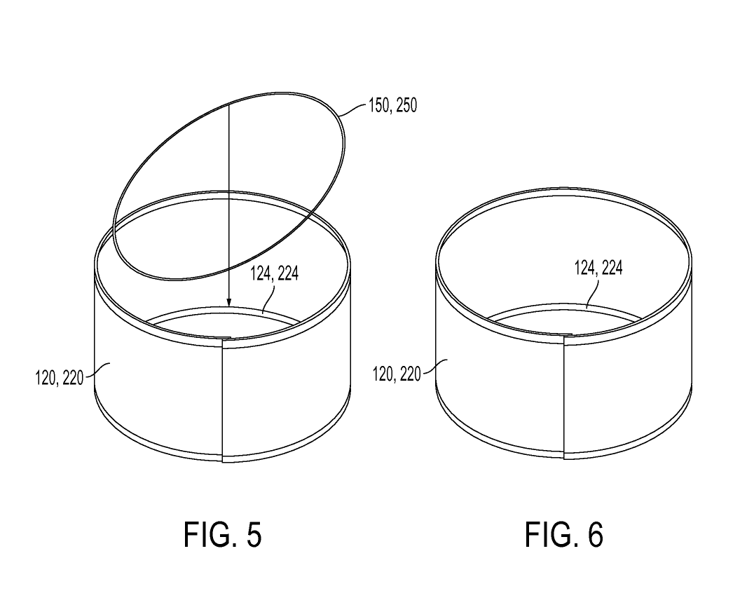

According to the example in FIG. 5, the now drum-shaped shade 120, 220 is receiving the plain ring 150, 250 into the lower bead 124, 224 in order to stiffen a lower half of the shade 120, 220. FIG. 6 shows the shade 120, 220 with the plain ring 150, 250 (not shown) hidden inside the lower bead 124, 224.

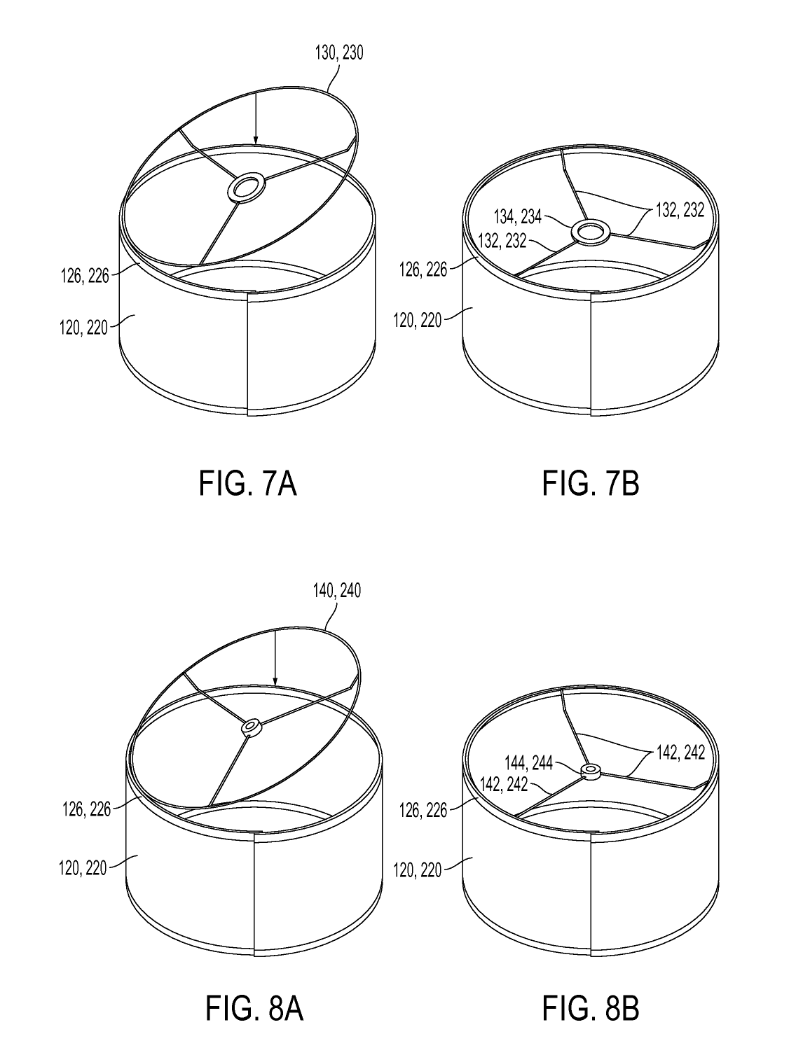

Also according to the example demonstrated in FIG. 7A, the shade 120, 220 is receiving the swag-type spider ring 130 230 into the upper bead 126, 226 in order to stiffen an upper half of the shade 120, 220. FIG. 7B shows the shade 120, 220 with the swag-type spider ring 130, 230 (not shown) hidden inside the upper bead 126, 226. However, the three spider legs 132, 232 and the large inner swag ring 134, 234 are visible to the consumer.

Also, according to the example demonstrated in FIG. 8A, the shade 120, 220 is receiving the finial-type spider ring 140, 240 into the upper bead 126, 226 in order to stiffen an upper half of the shade 120, 220. FIG. 8B shows the shade 120, 220 with the finial-type spider ring 140, 240 (not shown) hidden inside the upper bead 126, 226. However, the three spider legs 142, 242 and the small inner finial ring 144, 244 are visible to the consumer.

FIGS. 9-11 show the lamp shades 120, 220 in three different configurations. In FIG. 9, the shades 120, 220 have their upper beads 126 and 226, respectively, secured by their swag rings 134 and 234, respectively, to an electrical socket 300 which hangs from an electrical cord 400 that is attached to a ceiling (not shown). The cord 400 may be either flexible or rigid. In FIG. 10, the shades 120 and 220 have their upper beads 126 and 226, respectively, secured by their swag rings 134 and 234, respectively, to an electrical socket 500 which is secured to a rigid electrical arch 600 that is attached to a wall (not shown) or to a vertical pole (also not shown). In FIG. 11, the shades 120 and 220 have their upper beads 126 and 226, respectively, tightly secured by their finial rings 144 and 244, respectively, between a finial 700 and a harp 800 that is attached to a vertical pole 900. The pole 900 may be short so that the portable lamp sits on a table, a desk, or a night stand. Alternately, the pole 900 may be long so that the lamp stands on a floor. Whether the pole 900 is short or long, the portable lamp has a solid base 1000, which may be formed in any suitable shape, e.g. circular or rectangular, in order to stabilize the lamp.

Although described specifically throughout the entirety of the disclosure, the representative examples have utility over a wide range of applications, and the above discussion is not intended and should not be construed to be limiting. The terms, descriptions and figures used herein are set forth by way of illustration only and are not meant as limitations. Those skilled persons in the art recognize that many variations are possible within the spirit and scope of the principles of the invention. While the examples have been described with reference to the figures, those persons skilled in the art are able to make various modifications to the described examples without departing from the scope of the following claims, and their equivalents.

What is claimed is:

1. A lamp shade kit (100, 200), which may be assembled by the following method, comprising:
forming a lamp shade (120, 220) into a drum shape by attaching two vertically oriented Velcro® strips (122, 222) to each other, said strips being arranged on opposite edges of the lamp shade;
inserting a plain ring (150, 250) into a lower bead (124, 224) formed along a lower periphery of the lamp shade; and
inserting a spider ring (130, 140, 230, 240) into an upper bead (126, 226) formed along an upper periphery of the lamp shade;
whereby the lamp shade kit is assembled and ready to be secured in place.

2. A kit of claim 1, further comprising:
preliminarily opening up the lamp shade into the drum shape.

3. A kit of claim 1, further comprising:
preliminarily unrolling the lamp shade into the drum shape from an initially rolled-up condition.

4. A kit of claim 1,
wherein the spider ring has at least three spider legs (132, 142, 232, 242).

5. A kit of claim 4,
wherein the spider legs are bent.

6. A kit of claim 1,
wherein the spider ring has a swag ring (134, 234) in its center.

7. A kit of claim 6,
wherein the swag ring is adapted to engage a hanging electrical socket (300, 500).

8. A kit of claim 1,
wherein the spider ring has a finial ring (144, 244) in its center.

9. A kit of claim 8,
wherein the finial ring is adapted to be secured tightly between a finial (700) and a harp (800) on a vertical pole (900) of a portable lamp.

10. A kit of claim 3,
wherein the plain ring and the spider ring are arranged inside one box (115) next to the lamp shade in its initially rolled-up condition, said one box and said rolled-up lamp shade being fitted inside another box (110).
